(19) United States
(12) Patent Application Publication
(10) Pub. No.: US 2026/0153067 A1
(43) Pub. Date: Jun. 4, 2026

(54) EXHAUST STRUCTURE OF ENGINE

(71) Applicant: MAZDA MOTOR CORPORATION, Hiroshima (JP)

(72) Inventors: Koichi YASHIRO, Hiroshima (JP); Taku KURAMASHI, Hiroshima (JP); Yoshiaki HAMAHATA, Hiroshima (JP)

(73) Assignee: MAZDA MOTOR CORPORATION, Hiroshima (JP)

(21) Appl. No.: 19/398,180

(22) Filed: Nov. 24, 2025

(30) Foreign Application Priority Data
Dec. 2, 2024 (JP) 2024-209500

(51) Int. Cl. F02M 26/15; F02M 26/35

(52) U.S. Cl. CPC F02M 26/15; F02M 26/35

(57) ABSTRACT

An engine exhaust structure has first and second purifying devices simply and stably supported in an exhaust passage, and a plurality of independent passages. The purifying devices are disposed on an engine body exhaust side and arranged in a flow direction of exhaust gas at a height lower than exhaust port opening ends. The independent passages are fixed to an engine exhaust-side surface in communication with respective exhaust port opening ends. A first connecting passage connects the respective exhaust port opening ends to an upstream end of the first purifying device, and a second connecting passage connects a downstream end of the first purifying device to an upstream end of the second purifying device. An EGR pipe at an EGR passage connects a portion of the engine exhaust-side surface to the second connecting passage, the portion being located at a position higher than a catalyst device.

### TECHNICAL FIELD

The present disclosure relates to an exhaust structure of an engine.

### BACKGROUND

Conventionally, it has been known that engines provided to vehicles or the like include a purifying device, such as a catalyst device or a filter, provided in an exhaust passage to purify exhaust gas. Japanese Patent Laid-Open No. 2006-9793, for example, discloses an exhaust structure of an engine in which a monolithic three-way catalyst converter is provided in an exhaust passage. Specifically, in the structure of Japanese Patent Laid-Open No. 2006-9793, the exhaust passage is provided with exhaust pipes and a collecting part, the exhaust pipes extending downward from a plurality of exhaust ports, the collecting part being connected to the lower ends of the exhaust pipes to collect exhaust gas, and a catalyst device (catalytic converter) is connected to the collecting part in an attitude extending downward from the collecting part.

When a plurality of purifying devices are provided in the exhaust passage, the exhaust performance of the engine can be further improved. However, the purifying devices have a relatively large weight and hence, in the case in which a plurality of purifying devices are provided in the exhaust passage, a support structure for supporting these purifying devices is required. However, when the respective purifying devices are simply supported by individual support members, there is a problem that the number of parts increases, leading to a complicated structure. Japanese Patent Laid-Open No. 2006-9793 does not take this point into consideration and, therefore, there is room for improvement.

### SUMMARY

The present disclosure has been made under the above-mentioned circumstances, to provide an engine exhaust structure allowing a plurality of purifying devices to be provided in an exhaust passage, and being capable of supporting the plurality of purifying devices in a stable manner with a simple structure.

To solve the above-mentioned problem, an engine exhaust structure of the present disclosure includes an engine body in which a plurality of cylinders and a plurality of exhaust ports are formed, the plurality of cylinders being arranged in a cylinder arrangement direction, which is predetermined, the plurality of exhaust ports extending from the plurality of cylinders; an intake passage through which intake air to be introduced into the engine body flows; an exhaust passage through which exhaust gas led out from the engine body flows; and an EGR passage connecting the exhaust passage to the intake passage.

The exhaust structure of the engine is such that when one side in an engine width direction which is orthogonal to the cylinder arrangement direction and an up-down direction is taken as an exhaust side, and an opposite side of the exhaust side is taken as an intake side, a plurality of exhaust port opening ends are open on an engine exhaust-side surface, which is a side surface of the engine body on the exhaust side, the plurality of exhaust port opening ends being outlets of the plurality of exhaust ports. The exhaust passage includes a first purifying device and a second purifying device which are disposed on the exhaust side of the engine body, and arranged in this order in a flow direction of exhaust gas at a height lower than the plurality of exhaust ports. A first connecting passage includes a plurality of independent passages fixed to the engine exhaust-side surface in such a way as to be in communication with the plurality of exhaust port opening ends, the first connecting passage connecting the plurality of exhaust port opening ends to an upstream end of the first purifying device. A second connecting passage connects a downstream end of the first purifying device to an upstream end of the second purifying device, and the EGR passage includes an EGR pipe that connects a portion of the engine exhaust-side surface to the second connecting passage, the portion being located at a position higher than the first purifying device.

With such a configuration, the upstream end of the first purifying device can be suspended on the engine exhaust-side surface by making use of the first connecting passage, and the downstream end of the first purifying device and the upstream end of the second purifying device can be suspended on the engine exhaust-side surface by making use of the second connecting passage and the EGR pipe. Further, the first connecting passage includes the plurality of independent passages that are individually in communication with the respective exhaust ports and hence, the upstream end of the first purifying device can be supported by the plurality of independent passages. Therefore, with such a configuration, the first purifying device and the second purifying device can be supported on the engine exhaust-side surface in a stable manner, while omitting support members for supporting the first purifying device and the second purifying device, or while reducing the number of support members. That is, with such a configuration, the plurality of purifying devices (the first purifying device and the second purifying device) can be provided in the exhaust passage, and these purifying devices can be supported in a stable manner with a simple structure.

In the above-mentioned configuration, it is preferable that the first connecting passage includes a collecting passage that is connected to downstream ends of the plurality of independent passages to collect exhaust gas that passes through the plurality of independent passages.

With such a configuration, it is possible to reduce a space occupied by the first connecting passage, compared with a case in which the entire first connecting passage is formed of a plurality of independent passages. Accordingly, the first purifying device can be supported on the engine exhaust-side surface in a stable manner by the plurality of independent passages, and the first connecting passage, that is, the exhaust passage, can be made compact.

In the above-mentioned configuration, it is preferable that the first purifying device is disposed on the exhaust side of the engine body in an attitude extending along the cylinder arrangement direction, the first connecting passage includes a swirling part that connects the collecting passage to the first purifying device to cause exhaust gas to swirl in the swirling part, the swirling part have a shape that cover one end of the first purifying device in the cylinder arrangement direction from the one side, and that causes exhaust gas led out from the collecting passage to swirl about an axis extending along the cylinder arrangement direction, and the plurality of independent passages and the collecting passage have, as a whole, a shape that is bent in such a way as to bulge toward the exhaust side from the plurality of exhaust port opening ends and to extend downward.

With this configuration, the swirling part has the shape that covers one end of the first purifying device in the longitudinal direction (cylinder arrangement direction) from the one side and hence, the first purifying device can be supported by the swirling part, that is, the first connecting passage, in a more stable manner. Further, by causing exhaust gas to swirl in the swirling part, it is possible to cause the exhaust gas to flow into the first purifying device in a dispersed state, that is, in a more uniform state, and hence, the entire exhaust gas can be properly purified by the first purifying device. In addition, with this configuration, the entire exhaust channel, extending from the respective exhaust port opening ends to the swirling part, is configured to extend into an arc shape about an axis extending in the cylinder arrangement direction. Accordingly, it is possible to promote swirling of exhaust gas in the swirling part about the axis extending along the cylinder arrangement direction, and to promote dispersion of the exhaust gas, thereby improving the exhaust gas purification performance of the first purifying device.

In the above-mentioned configuration, it is preferable that the plurality of exhaust port opening ends are formed at a center portion of the engine exhaust-side surface in the cylinder arrangement direction.

With such a configuration, the plurality of independent passages can be disposed close to each other and hence, these independent passages can be disposed in a compact manner.

In the above-mentioned configuration, it is preferable that the second purifying device is provided at a position that overlaps with the first purifying device when viewed along the engine width direction.

With such a configuration, it is possible to reduce the dimensions in the cylinder arrangement direction and the up-down direction of the space occupied by the first purifying device and the second purifying device and hence, the first purifying device and the second purifying device can be disposed in a compact manner.

In the above-mentioned configuration, it is preferable that the engine body includes a cylinder block and a cylinder head, the plurality of cylinders being formed in the cylinder block, the cylinder head being provided on an upper side of the cylinder block to cover the cylinder block, the first connecting passage and the EGR pipe being fixed to the cylinder head, and a block-side support member being fixed to the cylinder block, the block-side support member supporting the first purifying device and the second purifying device.

With such a configuration, the first purifying device and the second purifying device can be supported by the cylinder head and the cylinder block in a more stable manner.

In the above-mentioned configuration, it is preferable that the EGR passage includes an in-engine EGR passage that is formed in the engine body, and that is open on the engine exhaust-side surface, and the EGR pipe being fixed to the engine exhaust-side surface in a state in which an upper end of the EGR pipe is in communication with an opening end of the in-engine EGR passage, the opening end of the in-engine EGR passage being on the engine exhaust-side surface.

With such a configuration, the EGR pipe can be fixed to the engine exhaust-side surface by making use of a structure for connecting the EGR pipe to the in-engine EGR passage and hence, it is possible to further simplify the structure of the engine exhaust-side surface on a lateral side.

As has been described above, with the exhaust structure of an engine of the present disclosure, it is possible to improve exhaust performance by providing the plurality of purifying devices in the exhaust passage, and these purifying devices can be supported in a stable manner with a simple configuration.

### BRIEF DESCRIPTION OF THE DRAWINGS

FIG. 1 is a schematic plan view of an engine to which an exhaust structure of an engine according to one embodiment of the present disclosure is applied.

FIG. 2 is a schematic side view of the engine shown in FIG. 1, as viewed from the right side.

FIG. 3 is a schematic side view of the engine shown in FIG. 1, as viewed from the front side.

FIG. 4 is a schematic perspective view showing a portion of the engine shown in FIG. 1, as viewed obliquely from the front right.

FIG. 5 is a cross-sectional view showing, in an enlarged manner, a portion of the cross section taken along line V-V in FIG. 3.

FIG. 6 is a cross-sectional view showing, in an enlarged manner, a portion of the cross section taken along line VI-VI in FIG. 3.

FIG. 7 is a cross-sectional view showing, in an enlarged manner, a portion of the cross section taken along line VII-VII in FIG. 5.

FIG. 8 is a cross-sectional view showing, in an enlarged manner, a portion of the cross section taken along line VIII-VIII in FIG. 6.

FIG. 9 is a schematic side view of the engine with a cover attached, FIG. 9 corresponding to FIG. 2.

FIG. 10 is a schematic bottom view of the engine with the cover attached.

FIG. 11 is diagram showing, in an enlarged manner, a portion of the cross section taken along line VII-VII in FIG. 5 and an area around the line VII-VII, and is a cross-sectional view of the engine with the covers attached.

FIG. 12 is a cross-sectional view for illustrating the flow of exhaust gas in an exhaust passage, FIG. 12 corresponding to FIG. 7.

### DETAILED DESCRIPTION

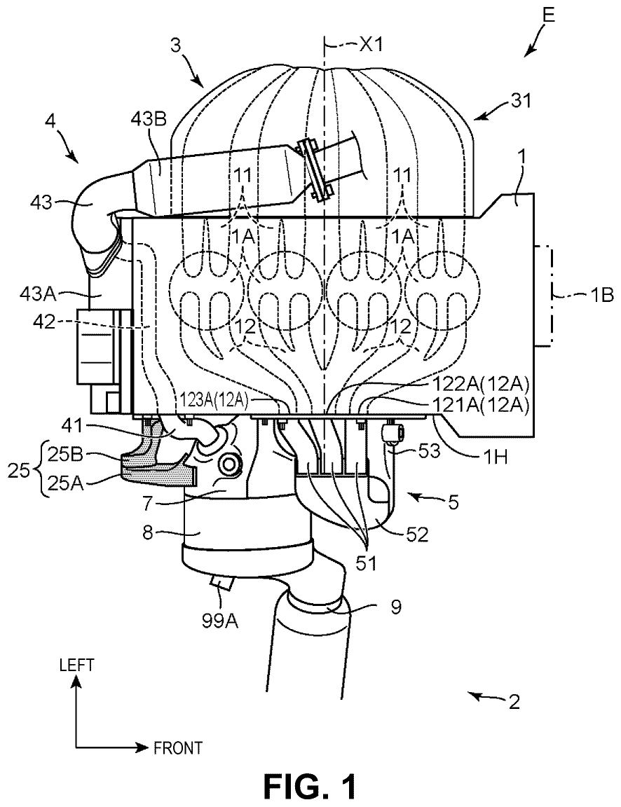

FIG. 1 is a schematic plan view of an engine E to which an exhaust structure of an engine according to one embodiment of the present disclosure is applied. The engine E of the present embodiment is an in-line four cylinder reciprocating engine, and four cylinders 1A arranged in a predetermined direction are formed in an engine body 1. A piston (not shown in the drawing) is fitted in each cylinder 1A and, when air-fuel mixture of fuel and air is combusted in each cylinder 1A, the piston reciprocates in the up-down direction, so that a crankshaft (not shown in the drawing) forming the output shaft of the engine E is rotated. The engine E of the present embodiment is a gasoline engine, and fuel containing gasoline as a main component is supplied into the respective cylinders 1A. A crank pulley 1B is attached to one end of the crankshaft in the longitudinal direction. Hereinafter, the arrangement direction of the cylinders 1A, that is, a cylinder arrangement direction, is referred to as “front-rear direction”, the side on which the crank pulley 1B is located (the right side in FIG. 1) is referred to as “front side”, and the opposite side of the front side is referred to as “rear side”. The left-right direction orthogonal to the up-down direction and the cylinder arrangement direction (front-rear direction), with the viewer facing the crank pulley 1B (front side), is referred to as “left-right direction”. In the present embodiment, the left-right direction corresponds to “engine width direction” in the present disclosure, the right side corresponds to “exhaust side”, and the left side corresponds to “intake side”. As described above, the front-rear direction corresponds to “cylinder arrangement direction” in the present disclosure, the front side corresponds to “one side” in the cylinder arrangement direction in the present disclosure, and the rear side corresponds to “the other side”.

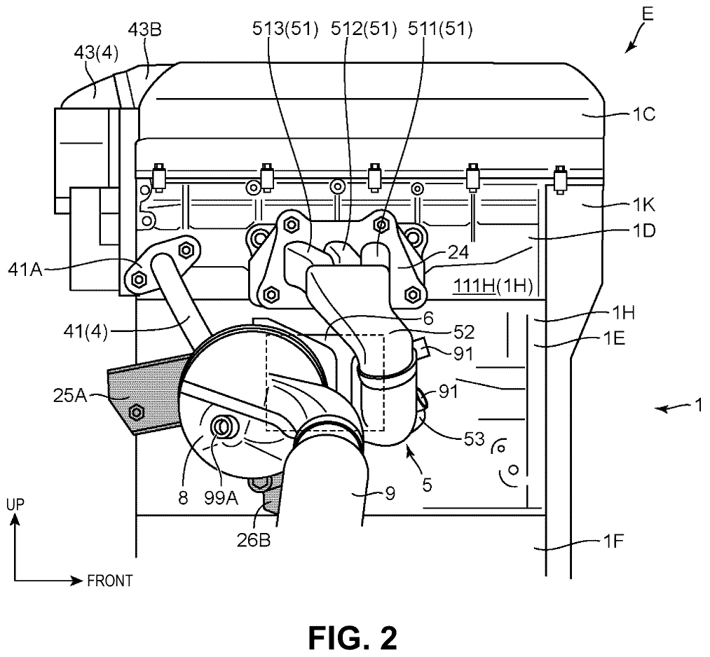

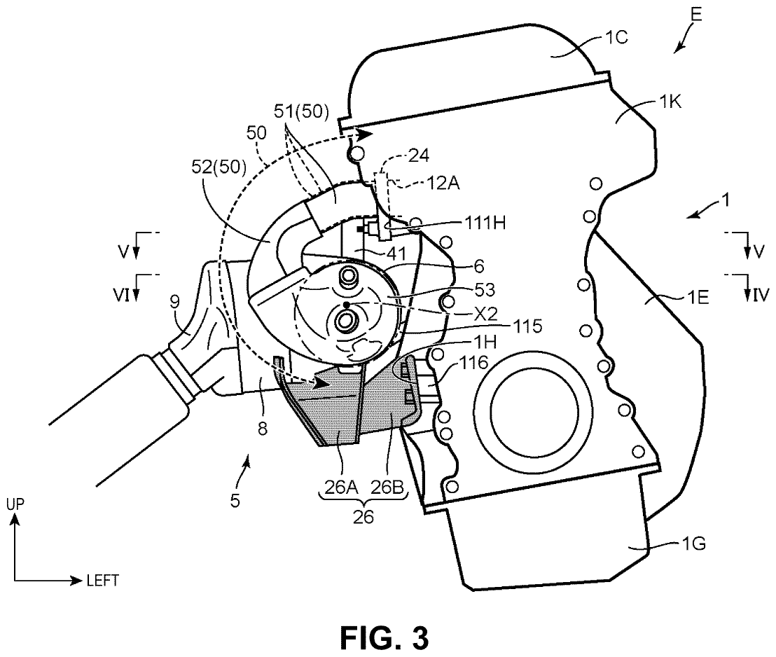

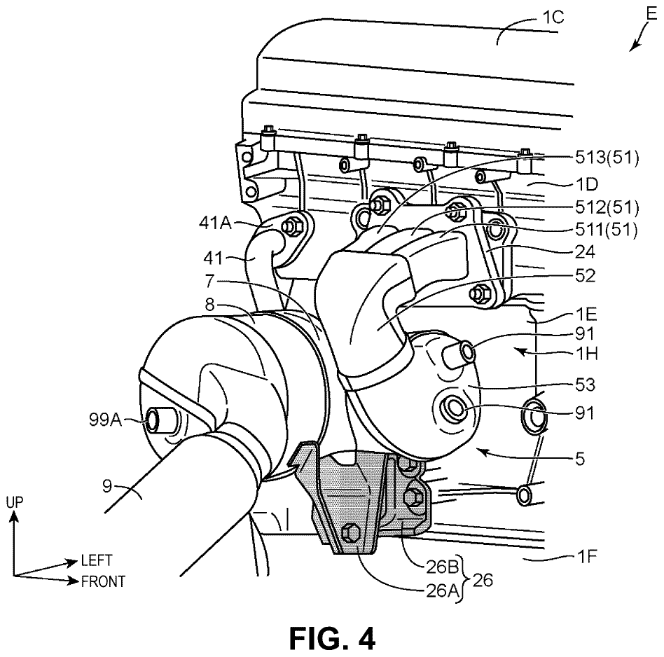

FIG. 2 is a schematic side view of the engine E as viewed from the right side. FIG. 3 is a schematic side view of the engine E as viewed from the front side. FIG. 4 is a schematic perspective view showing a portion of the engine E as viewed obliquely from the front right. FIG. 1 to FIG. 4 are diagrams showing a state in which an exhaust cover 22 and an EGR cover 400 described later are removed. In the diagrams in which a rear bracket 25 and a lower bracket 26 described later are shown as in the case of FIG. 1, these brackets 25, 26 are shown in a colored state to improve clarity of the drawing.

As shown in FIG. 1, the engine E includes the engine body 1, an exhaust passage 2, an intake passage 3, and an EGR passage 4. In the drawing, only a portion of the EGR passage 4 is shown.

As shown in FIG. 2, the engine body 1 includes a cylinder block 1E, a cylinder head 1D, which covers the upper side of the cylinder block 1E, a head cover 1C, which covers the upper side of the cylinder head 1D, and a crankcase 1F, which covers the lower side of the cylinder block 1E. The cylinders 1A are formed in the cylinder block 1E. As shown in FIG. 3, an oil pan 1G is attached to the lower surface of the crankcase 1F.

As shown in FIG. 1, the engine body 1 has a plurality of exhaust ports 12 and a plurality of intake ports 11, the plurality of exhaust ports 12 extending rightward from the respective cylinders 1A, the plurality of intake ports 11 extending leftward from the respective cylinders 1A. These ports 11, 12 are formed in the cylinder head 1D.

The exhaust ports 12 are open on an exhaust-side surface 1H of the engine body 1, the exhaust-side surface 1H forming the right side surface of the engine body 1. To be more specific, the exhaust ports 12 are open on the exhaust-side surface 1H at a portion formed by the cylinder head 1D, that is, on a right side surface 111H of the cylinder head 1D. Three opening ends 12A of the exhaust ports 12 are formed on the exhaust-side surface 1H, and the exhaust ports 12 extending from two cylinders 1A are collected in the engine body 1. The two cylinders 1A corresponding to the collected exhaust ports 12 are cylinders in which combustion does not occur continuously. Specifically, the engine E is controlled such that combustion occurs in sequence in four cylinders 1A at timings shifted by 180°CA, and combustion does not occur continuously between two adjacent cylinders 1A. In the present embodiment, combustion in the second cylinder 1A and the third cylinder 1A, counted from the front, does not occur continuously, and the exhaust ports 12 of these two cylinders 1A are collected in the engine body 1 to form one exhaust port 12, and the one exhaust port 12 is open on the exhaust-side surface 1H. Hereinafter, the opening end 12A of the exhaust port 12 formed on the exhaust-side surface 1H is referred to as “exhaust port opening end 12A”, when appropriate. Each exhaust port 12 is branched into two ports on the upstream side in the flow direction of exhaust gas, that is, on the cylinder 1A side, and two opening ends of the exhaust ports 12 are formed on the cylinder side for each cylinder 1A. The exhaust-side surface 1H described above corresponds to “engine exhaust-side surface” of the present disclosure.

Three exhaust port opening ends 12A are arranged in the front-rear direction. Hereinafter, when appropriate, the exhaust port opening end 12A on the frontmost side is referred to as “first opening end 121A”, the exhaust port opening end 12A at the center in the front-rear direction is referred to as “second opening end 122A”, and the exhaust port opening end 12A on the rearmost side is referred to as “third opening end 123A”.

The three exhaust port opening ends 12A are disposed at positions close to each other in the front-rear direction. In the present embodiment, the three exhaust port opening ends 12A are formed within a range occupied, in the front-rear direction, by two cylinders 1A (the second cylinder 1A and the third cylinder 1A, counted from the front) provided at the center. Specifically, when a line X1 passing through a point and extending in the left-right direction is taken as a center line X1, the second opening end 122A is provided on the center line X1, the point being located at the center of a region of four cylinders 1A in the front-rear direction, and being located at the center of two cylinders 1A in the front-rear direction, the two cylinders 1A being provided at the center. The first opening end 121A is provided slightly forward of the center line X1. The third opening end 123A is provided slightly rearward of the center line X1. In the present embodiment, the center line X1 substantially aligns with a line passing through the center of the engine body 1 (the cylinder head 1D) and the exhaust-side surface 1H in the front-rear direction, and extending in the left-right direction, and the three exhaust port opening ends 12A are formed at the center portion of the exhaust-side surface 1H in the front-rear direction.

The first opening end 121A is the opening end of the exhaust port 12 that is in communication with the cylinder 1A disposed on the frontmost side, and this exhaust port 12 is significantly bent obliquely toward the rear-right direction from the cylinder 1A. The second opening end 122A is the opening end of the exhaust port 12 that is in communication with the second and third cylinders 1A counted from the front, the exhaust port 12 extending from the second cylinder 1A counted from the front extends obliquely to the rear right from this cylinder 1A toward the second opening end 122A, and the exhaust port 12 extending from the third cylinder 1A counted from the front extends obliquely to the front right from this cylinder 1A toward the second opening end 122A. The third opening end 123A is the opening end of the exhaust port 12 that is in communication with the cylinder 1A disposed on the rearmost side, and this exhaust port 12 is significantly bent obliquely toward the front-right direction from the cylinder 1A.

The exhaust passage 2 is mounted on the exhaust-side surface 1H in a state of being in communication with the respective exhaust port opening ends 12A. The structure of the exhaust passage 2 will be described later.

The intake ports 11 are open on the left side surface of the engine body 1. The intake passage 3 includes an intake manifold 31 for distributing intake air to the respective cylinders 1A. The intake passage 3 is fixed to the right side surface of the engine body 1 in a state in which the intake manifold 31 is in communication with the opening ends of the respective intake ports 11. The illustration of a portion of the intake passage 3, which is located upstream of the intake manifold 31 in the flow direction of intake air, is omitted.

The EGR passage 4 is a passage for refluxing EGR gas, being a portion of exhaust gas flowing through the exhaust passage 2, to the intake passage 3, and connects the exhaust passage 2 to the intake passage 3. The halfway portion of the EGR passage 4 is formed in the engine body 1. That is, the EGR passage 4 includes a second EGR passage 42, a first EGR passage 41, and a third EGR passage 43, the second EGR passage 42 being formed in the engine body 1, the first EGR passage 41 connecting the second EGR passage 42 to the exhaust passage 2, the third EGR passage 43 connecting the second EGR passage 42 to the intake passage 3. Hereinafter, the flow direction of EGR gas flowing from the exhaust passage 2 toward the intake passage 3 is simply referred to as “flow direction of EGR gas” when appropriate. The second EGR passage 42 described above corresponds to “in-engine EGR passage” of the present disclosure, and the first EGR passage 41 described above corresponds to “EGR pipe”.

The second EGR passage 42 is formed in the cylinder head 1D. As shown in FIG. 1, the second EGR passage 42 is formed at the rear end portion of the cylinder head 1D in such a way as to extend in the left-right direction. The end portion of the second EGR passage 42 on the right side, that is, the end portion on the upstream side in the flow direction of EGR gas, is open on the exhaust-side surface 1H at a portion formed by the cylinder head 1D, that is, at the rear end portion of the right side surface 111H of the cylinder head 1D. The left end portion of the second EGR passage 42, that is, the end portion on the downstream side in the flow direction of EGR gas, is open at the left end portion of the rear surface of the cylinder head 1D.

As shown in FIG. 2 and the like, the first EGR passage 41 is disposed to the right of the right side surface 111H of the cylinder head 1D, and is in communication with the opening end of the second EGR passage 42 on the upstream side in the flow direction of EGR gas, this opening end of the second EGR passage 42 being formed on the right side surface 111H. The first EGR passage 41 connects this opening end of the second EGR passage 42 on the upstream side to a second connecting passage 7 described later of the exhaust passage 2. The second connecting passage 7 is located at the position lower than the opening end of the second EGR passage 42 on the upstream side. The second EGR passage 42 has the upper end thereof being in communication with the opening end of the second EGR passage 42 on the upstream side, extends downward from this opening end, and has the lower end portion thereof connected to the second connecting passage 7. To be more specific, as shown in FIG. 1, FIG. 4, and the like, the first EGR passage 41 extends rightward from the above-mentioned opening end and, thereafter, extends obliquely toward the lower front.

An EGR mounting member 43A having a block shape is mounted on the rear surface of the cylinder head 1D, a passage that is in communication with the second EGR passage 42 being formed in the EGR mounting member 43A. The third EGR passage 43 is coupled to the EGR mounting member 43A in a state of being in communication with this passage formed in the EGR mounting member 43A. The third EGR passage 43 extends upward from the EGR mounting member 43A and, thereafter, extends forward, and is connected to the portion (not shown in the drawing) of the intake passage 3, which is located upstream of the intake manifold 31 in the flow direction of intake air. An EGR cooler 43B for cooling EGR gas is provided at the halfway portion of the third EGR passage 43.

### Detailed Structure of Exhaust Passage

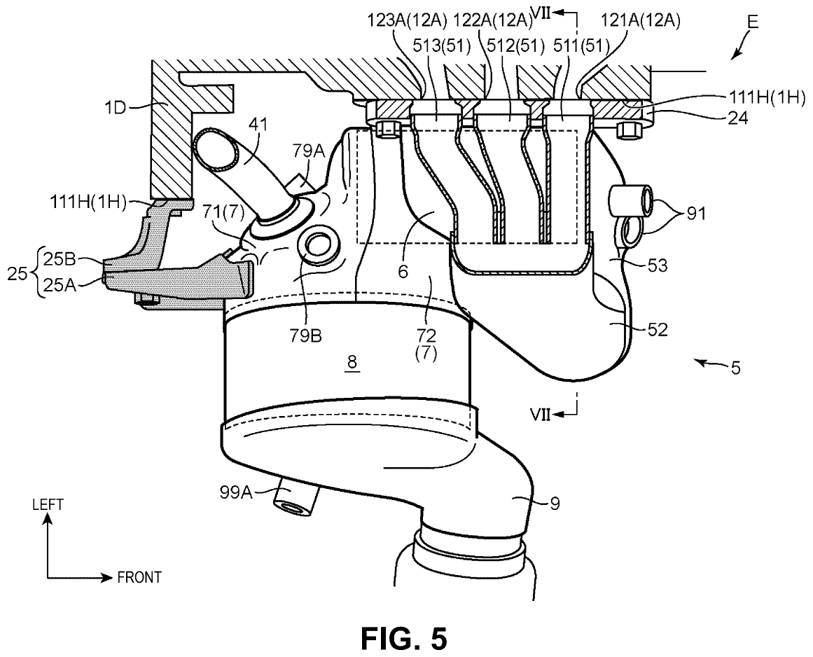

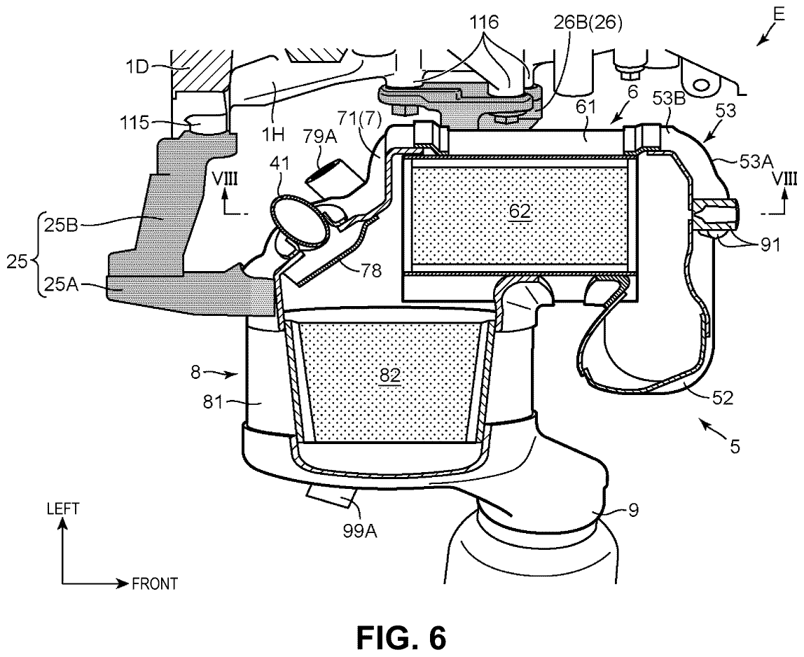

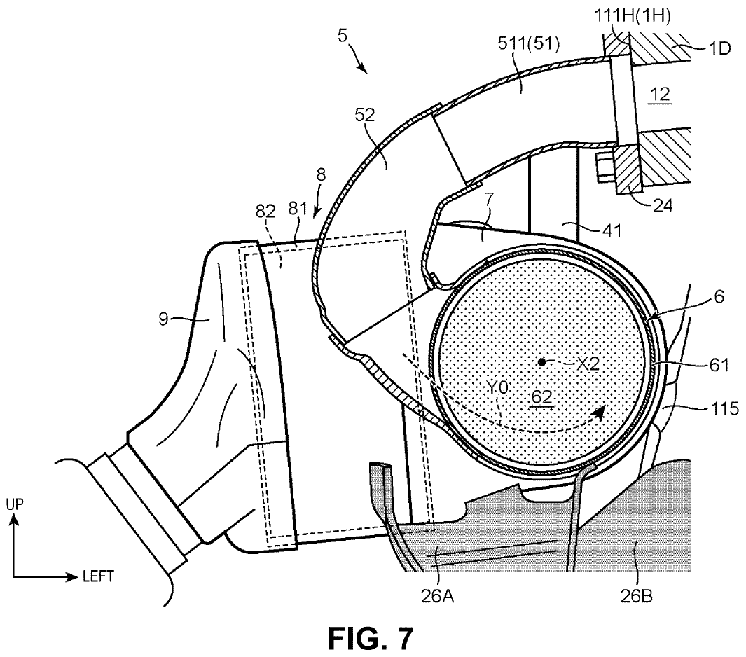

Next, the detailed structure of the exhaust passage 2 will be described. FIG. 5 is a cross-sectional view showing, in an enlarged manner, a portion of the cross section taken along line V-V in FIG. 3. FIG. 6 is a cross-sectional view showing, in an enlarged manner, a portion of the cross section taken along line VI-VI in FIG. 3. FIG. 7 is a cross-sectional view showing, in an enlarged manner, a portion of the cross section taken along line VII-VII in FIG. 5. In the following description for the exhaust passage 2, the upstream side and the downstream side in the flow direction of exhaust gas are simply referred to as “upstream side” and “downstream side” respectively, when appropriate.

The exhaust passage 2 includes a catalyst device 6 and a filter 8. The filter 8 is provided downstream of the catalyst device 6. The exhaust passage 2 includes a first connecting passage 5, the second connecting passage 7, and a third connecting passage 9, the first connecting passage 5 connecting the respective exhaust port opening ends 12A to the upstream end of the catalyst device 6, the second connecting passage 7 connecting the downstream end of the catalyst device 6 to the upstream end of the filter 8, the third connecting passage 9 extending toward the downstream side from the downstream end of the filter 8. The catalyst device 6 corresponds to “first purifying device” of the present disclosure, and the filter 8 corresponds to “second purifying device”.

The catalyst device 6 is a device that purifies exhaust gas by the action of the catalyst. As shown in FIG. 6 and the like, the catalyst device 6 has a substantially cylindrical shape. Specifically, the catalyst device 6 includes a catalyst case 61 and a catalyst body 62, the catalyst case 61 having a substantially cylindrical shape, the catalyst body 62 being disposed in the catalyst case 61, and having a substantially circular columnar shape. In the present embodiment, the catalyst body 62 is a monolithic catalyst converter, and a three-way catalyst is supported on the catalyst body 62.

The catalyst device 6 is disposed to the right of the exhaust-side surface 1H in an attitude extending in the front-rear direction (to be more specific, in an attitude in which the center axis of the catalyst device 6 extends in the front-rear direction). As shown in FIG. 2 and the like, the catalyst device 6 is disposed at a position lower than the exhaust port opening ends 12A, that is, at a height position lower than the exhaust port opening ends 12A, and is disposed to the right of the right side surface of the cylinder block 1E, the right side surface of the cylinder block 1E forming a portion of the exhaust-side surface 1H. As shown in FIG. 3 and the like, in the present embodiment, the catalyst device 6 is disposed at a position close to the exhaust-side surface 1H.

The first connecting passage 5 is in communication with the front end surface of the catalyst device 6, and connects the front end of the catalyst device 6 to the respective exhaust port opening ends 12A. The second connecting passage 7 is in communication with the rear end surface of the catalyst device 6, and connects the rear end of the catalyst device 6 to the filter 8. Exhaust gas that passes through the first connecting passage 5 flows into the catalyst device 6 from the front end surface of the catalyst device 6, and is led out to the second connecting passage 7 from the rear end surface of the catalyst device 6. As described previously, in the present embodiment, the front end of the catalyst device 6 forms the upstream end of the catalyst device 6, and the rear end of the catalyst device 6 forms the downstream end of the catalyst device 6.

The filter 8 is a device that captures fine particles in exhaust gas, thereby purifying the exhaust gas. As described above, the engine E of the present embodiment is a gasoline engine, and the filter 8 is a so-called GPF (Gasoline Particulate Filter). As shown in FIG. 6 and the like, the filter 8 has a substantially circular columnar shape. Specifically, the filter 8 includes a filter case 81 and a filter body 82, the filter case 81 having a substantially cylindrical shape, the filter body 82 being disposed in the filter case 81, and having a substantially circular columnar shape. In the present embodiment, the filter body 82 is formed of a ceramic filter having a honeycomb structure. As shown in FIG. 3 and the like, the filter 8 is disposed to the right of the exhaust-side surface 1H and obliquely behind and to the right of the catalyst device 6 in an attitude extending in the left-right direction (to be more specific, in an attitude in which the center axis of the filter 8 extends in the left-right direction). The filter 8 is disposed at a position lower than the exhaust port opening ends 12A, that is, at a height position lower than the exhaust port opening ends 12A.

As shown in FIG. 6 and the like, in the front-rear direction, the filter 8 is disposed in a region ranging from the vicinity of the center of the catalyst device 6 in the front-rear direction to a position rearward of the catalyst device 6. As shown in FIG. 7 and the like, the height position of the filter 8 is substantially equal to the height position of the catalyst device 6. Thus, the front portion of the filter 8 overlaps with the rear portion of the catalyst device 6 in the left-right direction. In the present embodiment, the substantially front half of the filter 8 and the substantially rear half of the catalyst device 6 overlap with each other when viewed in the left-right direction, that is, when viewed along the left-right direction.

The second connecting passage 7 is in communication with the left end surface of the filter 8, and the third connecting passage 9 is in communication with the right end surface of the filter 8. Exhaust gas that passes through the second connecting passage 7 flows into the filter 8 from the left end surface of the filter 8, and is led out to the third connecting passage 9 from the right end surface of the filter 8. As described previously, in the present embodiment, the left end of the filter 8 forms the upstream end of the filter 8, and the right end of the filter 8 forms the downstream end of the filter 8.

### First Connecting Passage

The first connecting passage 5 includes a plurality of independent passages 51, a collecting passage 52, and a swirling part 53. As described above, the first connecting passage 5 is a passage that connects the respective exhaust port opening ends 12A to the catalyst device 6. The catalyst device 6 is disposed at the position lower than the respective exhaust port opening ends 12A. Thus, the first connecting passage 5 extends upward from the catalyst device 6. As shown in FIG. 3 and the like, in the present embodiment, a portion of the downstream portion of the collecting passage 52 is integrally formed with the swirling part 53.

The respective independent passages 51 are passages individually extending from the respective exhaust port opening ends 12A, and are fixed to the exhaust-side surface 1H in a state of being in communication with the respective exhaust port opening ends 12A. In the present embodiment, three independent passages 51 are provided in the exhaust passage 2 such that the three independent passages 51 correspond to the three exhaust port opening ends 12A. That is, as shown in FIG. 5 and the like, the exhaust passage 2 includes, as the independent passages 51, a first independent passage 511 connected to the first opening end 121A, a second independent passage 512 connected to the second opening end 122A, and a third independent passage 513 connected to the third opening end 123A. The three independent passages 511 to 513 have substantially the same cross sectional shape, and have a substantially rectangular shape extending in the up-down direction.

The three independent passages 51 (511 to 513) extend rightward from the corresponding opening ends 12A (121A to 123A), and these independent passages 51 (511 to 513) are arranged in the front-rear direction. As described above, the three exhaust port opening ends 12A (121A to 123A) are formed at the center portion of the exhaust-side surface 1H in the front-rear direction. Due to this, the three independent passages 51 (511 to 513) extending from the respective exhaust port opening ends 12A (121A to 123A) are disposed close to each other at a position that faces the center portion of the exhaust-side surface 1H in the front-rear direction. Specifically, in the present embodiment, as shown in FIG. 5 and the like, a gap dimension between the respective independent passages 51 (511 to 513) in the front-rear direction is set to a dimension smaller than the dimension of each of these independent passages 51 (511 to 513) in the front-rear direction.

To be more specific, in the embodiment, as shown in FIG. 5 and the like, the first independent passages 511 extends substantially straight toward the right from the first opening end 121A when viewed in a plan view (that is, when viewed along the up-down direction). Although the upstream portions, that is, the left portions, of the second independent passage 512 and the third independent passage 513 are slightly inclined obliquely toward the front right from the corresponding opening ends 122A, 123A when viewed in a plan view, the downstream portions, that is, the right side portions, of the second independent passage 512 and the third independent passage 513 extend substantially straight in the left-right direction when viewed in a plan view. The inclination angle of the upstream portion of the second independent passage 512 relative to the left-right direction is smaller than the inclination angle of the upstream portion of the third independent passage 513. As described previously, the upstream portions of the three independent passages 511 to 513 have different inclination angles relative to the left-right direction. However, this difference is small, and the three independent passages 511 to 513 are arranged side by side at positions close to each other in an attitude in which the three independent passages 511 to 513 are nearly parallel to each other.

As shown in FIG. 3, FIG. 4, and the like, the three independent passages 51 (511 to 513) are configured to have substantially the same shape, and to pass through substantially the same position, when viewed in the front-rear direction. Thus, almost all of the three independent passages 51 (511 to 513) overlap with each other when viewed in the front-rear direction.

As shown in FIG. 3, FIG. 4, and the like, the three independent passages 51 (511 to 513) are bent in such a way as to bulge in the right-upward direction from the exhaust port opening ends 12A (121A to 213A) and to extend obliquely toward the lower right. That is, these independent passages 51 (511 to 513) are bent to extend along an arc about a point located below the exhaust port opening ends 12A (121A to 213A), when viewed in the front-rear direction.

The catalyst device 6 is disposed below the three independent passages 51 (511 to 513) and, as shown in FIG. 5 and the like, the catalyst device 6 overlaps with the three independent passages 51 (511 to 513) when viewed in a plan view. In the present embodiment, almost all of the three independent passages 51 (511 to 513) overlap with the catalyst device 6. Specifically, the position of the front end of the first independent passage 511 is located slightly forward of the position of the front end of the catalyst device 6, the position of the rear end of the third independent passage 513 is located forward of the rear end of the catalyst device 6 by approximately ⅓ of the entire length of the catalyst device 6, and the three independent passages 51 (511 to 513) overlap with a portion of the catalyst device 6, the portion starting from the front side of the catalyst device 6, and being approximately ⅔ of the entire length of the catalyst device 6.

As shown in FIG. 3 and the like, the collecting passage 52 connects the three independent passages 51 to the swirling part 53, which is located below these three independent passages 51. The collecting passage 52 is commonly connected to the downstream ends of the three independent passages 51, and extends downward from these downstream ends. As shown in FIG. 5, one passage is formed in the collecting passage 52, and exhaust gas that passes through the three independent passages 51 is collected in the collecting passage 52. The cross section of the upper end, that is, the upstream end, of the collecting passage 52 has a substantially rectangular shape extending in the front-rear direction. In contrast, as shown in FIG. 6, the cross section of the downstream portion of the collecting passage 52 has a substantially circular shape. The dimension of the collecting passage 52 in the front-rear direction gradually decreases toward the downstream side, and the dimension of the collecting passage 52 in the left-right direction gradually increases toward the downstream side.

As shown in FIG. 3, an upstream-side passage 50 is a passage formed of the three independent passages 51 and the collecting passage 52, and is bent in such a way as to bulge toward the right and to extend downward, when viewed in the front-rear direction. Specifically, the collecting passage 52 is bent in such a way as to bulge toward the right. When the collecting passage 52 and the independent passages 51 are viewed in the front-rear direction, the curvature of the collecting passage 52 is substantially equal to the curvature of each independent passage 51. The downstream ends of the respective independent passages 51 are open obliquely toward the lower right, and the upstream end of the collecting passage 52 is open obliquely toward the upper left. When the collecting passage 52 and the independent passages 51 are viewed in the front-rear direction, the tangent to the upstream end of the collecting passage 52 substantially aligns with the tangent to the downstream ends of the respective independent passages 511 to 513. Thus, when viewed in the front-rear direction, the three independent passages 51 are smoothly connected to the collecting passage 52, and the upstream-side passage 50, as a whole, is smoothly bent in such a way as to bulge toward the right from the exhaust port opening ends 12A and to extend downward.

The swirling part 53 connects the upstream end of the catalyst device 6 to the downstream end of the collecting passage 52. As shown in FIG. 6, the swirling part 53 is provided in front of the catalyst device 6, and covers the front end surface of the catalyst device 6 from the front. As shown in FIG. 3 and the like, the swirling part 53 has a substantially circular shape when viewed in the front-rear direction (that is, when viewed along the front-rear direction), and has an inner peripheral surface having a substantially circular shape when viewed in the front-rear direction. In the present embodiment, a center axis X2 of the swirling part 53, the center axis X2 extending in the front-rear direction, substantially aligns with a center axis X2 of the catalyst device 6, the center axis X2 extending in the front-rear direction. Further, the outer diameter of the swirling part 53 is substantially equal to the outer diameter of the catalyst device 6, and the swirling part 53 has a substantially bowl shape extending forward from the outer peripheral edge of the front end portion of the catalyst device 6. Specifically, the swirling part 53 includes a front end surface 53A and an outer peripheral portion 53B, the front end surface 53A forming the front end surface of the swirling part 53, and having a substantially circular shape when viewed in the front-rear direction, the outer peripheral portion 53B extending in the front-rear direction between the outer peripheral edge of the front end surface 53A and the outer peripheral edge of the front end portion of the catalyst device 6, the diameter of the outer peripheral portion 53B gradually increasing toward the rear side.

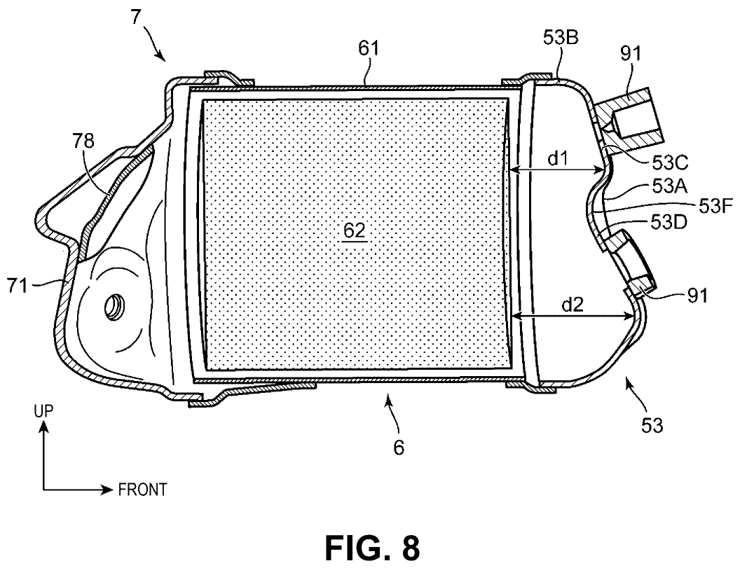

FIG. 8 is a cross-sectional view taken along line VIII-VIII in FIG. 6, and is a cross-sectional view of the swirling part 53 taken along the plane extending in the front-and-rear direction and the up-down direction along the center axis X2 of the swirling part 53. In the cross section shown in FIG. 8, with regard to the separation distance between the inner peripheral surface of the swirling part 53 (to be more specific, the rear surface of the front end surface 53A) and a front end surface 6A of the catalyst device 6 in the front-rear direction, the separation distance at an upper area (d1) is smaller than that of at a lower area (d2), the upper area being located above the center axis X2, the lower area being located below the center axis X2. To be more specific, a bulging part 53F, which slightly bulges rearward, is formed in the vicinity of the center of the front end surface 53A, and the maximum value of the above-mentioned separation distance d1 for an upper part 53C is set to a dimension smaller than the minimum value of the above-mentioned separation distance for a lower part 53D, the upper part 53C being located above the bulging part 53F of the swirling part 53, the lower part 53D being located below the bulging part 53F.

Both the upper part 53C and the lower part 53D are inclined obliquely toward the lower front, the upper part 53C being located above the bulging part 53F of the swirling part 53, the lower part 53D being located below the bulging part 53F of the swirling part 53. The swirling part 53, as a whole, is inclined obliquely toward the lower front. Mounting parts 91, 91 for mounting sensors are provided to the upper part 53C and the lower part 53D, the upper part 53C being located above the bulging part 53F of the swirling part 53, the lower part 53D being located below the bulging part 53F of the swirling part 53. In the present embodiment, an O2 sensor is mounted on the upper mounting part 91, and a temperature sensor is mounted on the lower mounting part 91. As described above, the respective parts 53C, 53D are inclined obliquely toward the lower front, and the respective mounting parts 91 extend obliquely toward the upper front from the front end surface 53A.

The swirling part 53 is configured to cause, in the inside thereof, exhaust gas to swirl about an axis extending in the front-rear direction.

Specifically, the downstream end of the collecting passage 52, that is, the downstream end of the upstream-side passage 50, is in communication with the lower portion of the right side surface of the swirling part 53. In the present embodiment, a region of the right side surface of the swirling part 53 is in communication with the downstream end of the upstream-side passage 50, the region ranging from the position of the lower end of the right side surface of the swirling part 53 to the position located below the upper end of the right side surface of the swirling part 53 by a length corresponding to approximately ¼ of the diameter of the swirling part 53. As described previously, the upstream-side passage 50 extends rightward from the lower portion of the right side surface of the swirling part 53, and is bent in such a way as to bulge toward the right as described above. Thus, when viewed in the front-rear direction, the upstream-side passage 50 is smoothly connected to the swirling part 53, and the upstream-side passage 50 extends into a substantially arc shape along the inner peripheral surface of the lower portion of the swirling part 53, that is, along the inner peripheral surface in the vicinity of the connection portion between the swirling part 53 and the collecting passage 52.

As described above, the downstream end of the upstream-side passage 50 (the downstream end of the collecting passage 52) is in communication with the lower portion of the swirling part 53 and hence, exhaust gas that passes through the upstream-side passage 50 is introduced into the lower portion of the swirling part 53. Thus, as shown by an arrow Y0 in FIG. 7, the exhaust gas flows into the swirling part 53 along the inner peripheral surface of the lower portion of the swirling part 53, and swirls about the center axis X2 of the swirling part 53 along this inner peripheral surface.

### Second Connecting Passage

As shown in FIG. 5 and the like, the second connecting passage 7, as a whole, extends obliquely to the rear right from the downstream portion, that is, the rear portion, of the catalyst device 6 toward the left end surface of the filter 8, and connects the rear portion of the catalyst device 6 to the left end portion of the filter 8. As shown in FIG. 6 and the like, the downstream portion of the catalyst device 6 is inserted into the second connecting passage 7, the downstream portion including the downstream end of the catalyst device 6 and a portion located upstream of this downstream end. The second connecting passage 7 connects the catalyst device 6 to the filter 8 with the downstream portion of the catalyst device 6 housed in the second connecting passage 7.

Specifically, as shown in FIG. 5, FIG. 6, and the like, the rear portion of the second connecting passage 7 (hereinafter referred to as “second connecting rear portion 71” when appropriate) extends from the rear portion of the outer peripheral edge of the upstream end (left end) of the filter 8 toward the downstream end (rear end) of the catalyst device 6, and covers the rear portion of the filter 8 from the left, and covers the catalyst device 6 from the rear. The second connecting rear portion 71 has an approximately ¼ spherical shape (a shape obtained by further halving a hemisphere along the plane passing through the center) and, when viewed in a plan view, the rear edge of the second connecting rear portion 71 is inclined obliquely toward the rear right. The front portion of the second connecting passage 7 (hereinafter referred to as “second connecting front portion 72” when appropriate) extends rightward from the outer peripheral surface of the catalyst device 6 toward the front portion of the filter 8. As shown in FIG. 6, the second connecting front portion 72 connects the outer peripheral surface of a portion of the catalyst device 6 to the upstream end (left end) of the filter 8, the portion being located forward (upstream) of the vicinity of the rear end (downstream end) of the catalyst device 6. A portion of the filter 8 and a portion of the catalyst device 6 that overlap with each other when viewed in the left-right direction, specifically, the front portion of the filter 8 and the rear portion of the catalyst device 6, face each other in the left-right direction in the second connecting front portion 72.

In the left-right direction, the amount of the second connecting passage 7 extending rightward from the catalyst device 6 is small, and the filter 8, which is disposed downstream of the second connecting passage 7, is close to the catalyst device 6. Due to this, as shown in FIG. 7, the filter 8 overlaps with the collecting passage 52 when viewed in the front-rear direction. In the present embodiment, the left upper portion of the filter 8 overlaps with the downstream portion of the upstream-side passage 50 when viewed in the front-rear direction.

The lower end portion (the upstream end in the flow direction of EGR gas) of the first EGR passage 41 is connected to the rear surface of the second connecting passage 7, and the first EGR passage 41 extends upward from this rear surface. In the present embodiment, a portion of exhaust gas that passes through the catalyst device 6 and is introduced into the second connecting passage 7 is refluxed, as EGR gas, to the intake passage 3 through the first EGR passage 41 and the EGR passage 4.

As shown in FIG. 6, in the present embodiment, a shielding plate 78 is provided in the second connecting passage 7 at a position that faces the lower end portion of the first EGR passage 41. The shielding plate 78 is provided to prevent metal powder and the like contained in exhaust gas from flowing into the EGR passage 4, that is, to prevent occurrence of so-called contamination in the EGR passage 4, and the shielding plate 78 is configured to cause exhaust gas led out from the catalyst device 6 to flow into the first EGR passage 41 while routing around the shielding plate 78. Specifically, the shielding plate 78 has a plate shape extending substantially parallel to the rear surface of the second connecting passage 7 and, at a position upstream (in the flow direction of exhaust gas) of a position that faces the downstream end of the first EGR passage 41, the shielding plate 78 is fixed to the inner peripheral surface of the second connecting passage 7 in a state of being in contact with the inner peripheral surface of the second connecting passage 7. A cylindrical member 79A shown in FIG. 5 and the like and provided to the second connecting passage 7 is a member to which a pipe is mounted, the pipe guiding exhaust gas to a differential pressure sensor. An opening portion to which reference symbol “79B” is given, and that is formed in the second connecting passage 7 is an opening portion for mounting a sensor.

### Third Connecting Passage

As shown in FIG. 1 and the like, the third connecting passage 9 extends rightward from the right end portion of the filter 8. In the present embodiment, the third connecting passage 9 slightly extends rightward from the right end portion of the filter 8 and, thereafter, extends obliquely toward the front right, and then extends rightward. As shown in FIG. 5, a cylindrical member 99A for mounting a pipe is also provided to the third connecting passage 9 in the same manner as the second connecting passage 7, the pipe guiding exhaust gas to the differential pressure sensor.

### Cover Member

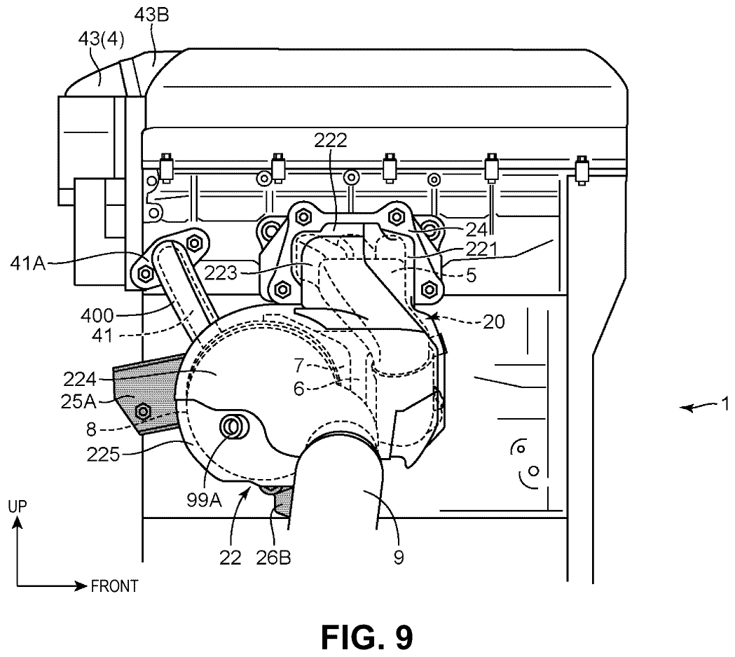

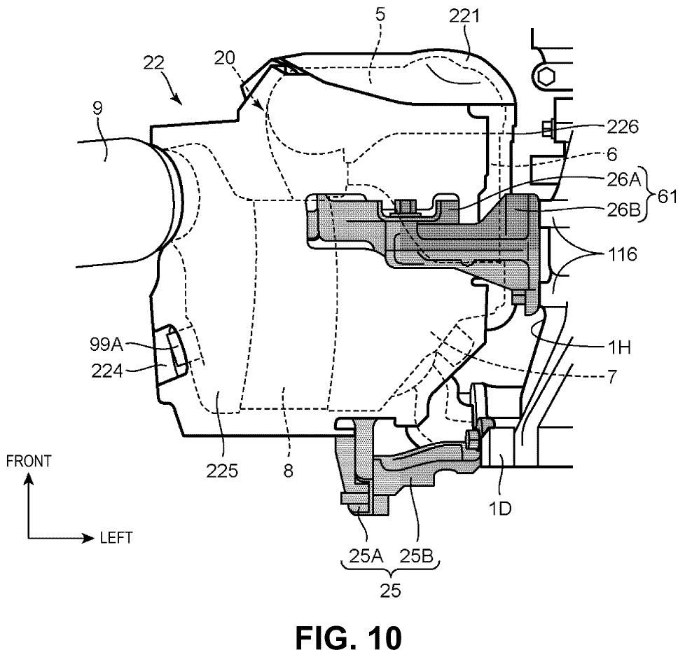

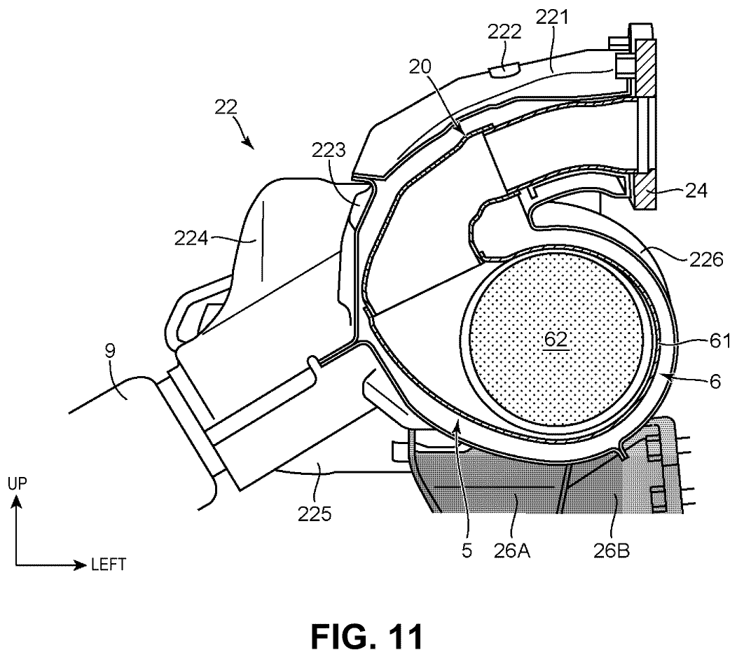

In the present embodiment, the first connecting passage 5, the catalyst device 6, the second connecting passage 7, and the filter 8 are integrally covered by the exhaust cover 22. The first EGR passage 41 is surrounded by the EGR cover 400. Hereinafter, these covers 22, 400 will be described. FIG. 9 is a diagram corresponding to FIG. 2, and is a schematic side view of the engine E with the exhaust cover 22 and the EGR cover 400 attached. FIG. 10 is a diagram showing, in an enlarged manner, a portion of the bottom view of the engine E with the exhaust cover 22 and the EGR cover 400 attached. FIG. 11 is a diagram showing, in an enlarged manner, a portion of the cross section taken along line VII-VII in FIG. 5, and an area around the line VII-VII, and is a cross-sectional view of the engine with the exhaust cover 22 and the EGR cover 400 attached.

The exhaust cover 22 covers substantially all of the upstream-side passage 50 (the first connecting passage 5 and the swirling part 53), the catalyst device 6, the second connecting passage 7, and the filter 8, and covers a portion of the third connecting passage 9 which is located in the vicinity of the upstream end of the third connecting passage 9. Hereinafter, when appropriate, the upstream-side passage 50, the catalyst device 6, the second connecting passage 7, the filter 8, and the portion of the third connecting passage 9 which is covered by the exhaust cover 22 and which is located in the vicinity of the upstream end of the third connecting passage 9 are referred to as “exhaust module 20”. The exhaust cover 22 has a shape substantially extending along the outer surface of the exhaust module 20. As will be described later, brackets are mounted on the exhaust module 20, the brackets allowing exhaust module 20 to be supported on the engine body 1. The exhaust cover 22 covers substantially the entire region of the outer surface of the exhaust module 20, excluding the portions at which the above-mentioned sensors, such as the O2 sensor, are mounted, and the portions at which the brackets are mounted.

The exhaust cover 22 is constituted of a plurality of cover members. In the present embodiment, the exhaust cover 22 is constituted of six cover members (a first cover 221, a second cover 222, a third cover 223, a fourth cover 224, a fifth cover 225, and a sixth cover 226).

As shown in FIG. 9 and FIG. 10, the first cover 221 mainly covers the front portion of the first connecting passage 5 from the top, the bottom, and the front. The second cover 222 is disposed behind the first cover 221, and mainly covers the left portion of the rear portion of the first connecting passage 5 from the top and the rear. The third cover 223 is disposed at a position behind the first cover 221 and to the right of the second cover 222, and mainly covers the right portion of the rear portion of the first connecting passage 5 from the top and the rear. The fourth cover 224 is disposed at a position to the right of and behind the third cover 223, and covers the rear portion of the catalyst device 6 and the second connecting passage 7 from the top, and covers the filter 8 and the portion of the third connecting passage 9 which is located in the vicinity of the upstream end of the third connecting passage 9 from the top, the right, and the front. As shown in FIG. 10, the fifth cover 225 covers substantially the entire exhaust module 20 from the bottom. The sixth cover 226 is disposed between the fifth cover 225 and the second and third covers 222, 223 and, as shown in FIG. 11, mainly covers the catalyst device 6 from the left, and covers the upstream portion of the first connecting passage 5 from the bottom. The adjacent covers 221 to 206 are coupled to each other and, as described above, substantially the entire exhaust module 20 is covered by these first to sixth covers 221 to 206.

As shown in FIG. 9, the EGR cover 400 has a cylindrical shape that allows the EGR cover 400 to house the first EGR passage 41 therein. In the present embodiment, substantially the entire first EGR passage 41 is covered by the EGR cover 400.

### Support Structure

The exhaust module 20 is supported on the cylinder head 1D by the first connecting passage 5 and the first EGR passage 41, which are included in the exhaust module 20. The exhaust module 20 is also supported on the cylinder block 1E by the rear bracket 25 and the lower bracket 26. Hereinafter, the support structure of the exhaust module 20 will be described. Each of the rear bracket 25 and the lower bracket 26 described above corresponds to “block-side support member” of the present disclosure.

As shown in FIG. 5, the upstream ends of the three independent passages 51 are coupled to each other by an independent passage mounting flange 24. The independent passage mounting flange 24 has a plate shape. The respective independent passages 51 are fixed to the independent passage mounting flange 24 in an attitude extending in the plate thickness direction of the independent passage mounting flange 24. For example, the upstream ends of the respective independent passages 51 are fixed by welding to the independent passage mounting flange 24. The independent passage mounting flange 24 is fixed to the right side surface 111H of the cylinder head 1D with bolts, and the three independent passages 51 are fixed to the right side surface 111H of the cylinder head 1D via the independent passage mounting flange 24. As described previously, in the present embodiment, the three independent passages 51, that is, the first connecting passage 5, are fixed to the right side surface 111H of the cylinder head 1D, so that the exhaust module 20 is supported on the cylinder head 1D. The independent passage mounting flange 24 is fixed to the right side surface 111H of the cylinder head 1D at a position near the center in the front-rear direction.

As described above, the lower end portion of the first EGR passage 41 is connected to the rear surface of the second connecting passage 7. For example, the lower end portion of the first EGR passage 41 is fixed by welding to the rear surface of the second connecting passage 7. In the present embodiment, as shown in FIG. 6, the lower end portion of the first EGR passage 41 is fixed to the second connecting passage 7 at a position that is in the vicinity of the center X2 of the catalyst device 6 and that overlaps with the swirling part 53 when viewed in the front-rear direction. The lower end portion of the first EGR passage 41 is fixed to the second connecting passage 7 at the position that overlaps with the filter 8 when viewed in the left-right direction.

As shown in FIG. 4 and the like, an EGR mounting flange 41A having a plate shape is fixed to the upper end portion of the first EGR passage 41. The first EGR passage 41 is fixed to the EGR mounting flange 41A in an attitude extending from the EGR mounting flange 41A in the plate thickness direction of the EGR mounting flange 41A. For example, the upper end portion of the first EGR passage 41 is fixed by welding to the EGR mounting flange 41A. The EGR mounting flange 41A is fixed to the right side surface 111H of the cylinder head 1D with bolts. Consequently, the first EGR passage 41 is supported on the right side surface 111H of the cylinder head 1D and, as a result, the exhaust module 20 is supported. In the present embodiment, the EGR mounting flange 41A is fixed to the rear end portion of the right side surface 111H of the cylinder head 1D.

Both the front and rear ends of the catalyst device 6 are suspended on the cylinder head 1D by the first connecting passage 5 and the first EGR passage 41. Specifically, the swirling part 53, which is provided in front of the catalyst device 6, is fixed to the front end portion of the catalyst device 6, so that the first connecting passage 5 and the catalyst device 6 are coupled to each other. In the present embodiment, as described above, in the first connecting passage 5, the portion of the downstream portion of the collecting passage 52 is integrally formed with the swirling part 53, and this integral body is fixed by welding or the like to the front end portion of the catalyst case 61. The second connecting passage 7 is fixed by welding or the like to the outer peripheral surface of the rear portion of the catalyst device 6. The first connecting passage 5 extends upward from the catalyst device 6, and connects a portion of the exhaust-side surface 1H to the catalyst device 6, the portion being located on the right side surface 111H of the cylinder head 1D at a position higher than the catalyst device 6. The first EGR passage 41 extends upward from the rear surface of the second connecting passage 7, and connects a portion of the exhaust-side surface 1H to the second connecting passage 7, the portion being located on the right side surface 111H of the cylinder head 1D at a position higher than the second connecting passage 7 and the catalyst device 6. Thus, the front end portion of the catalyst device 6 is suspended on the cylinder head 1D by the first connecting passage 5, and the rear end portion of the catalyst device 6 is suspended on the cylinder head 1D by the first EGR passage 41 via the second connecting passage 7.

The left end portion of the filter 8 is also suspended on the cylinder head 1D by the first EGR passage 41. Specifically, the right end portion of the second connecting passage 7 is fixed by welding or the like to the left end portion of the filter 8, so that the second connecting passage 7 is coupled to the filter 8. As described above, the first EGR passage 41 extends upward from the rear surface of the second connecting passage 7. Thus, the left end portion of the filter 8 is mainly suspended on the cylinder head 1D by the first EGR passage 41 via the second connecting passage 7.

As shown in FIG. 6, the rear bracket 25 is constituted of two brackets (a first rear bracket 25A, a second rear bracket 25B). The first rear bracket 25A has a substantially plate shape. The first rear bracket 25A is fixed by welding or the like to the rear surface of the second connecting passage 7 in an attitude extending rearward from this rear surface. As shown in FIG. 2, the first rear bracket 25A extends rearward from the vicinity of the center of the rear surface of the second connecting passage 7 in the up-down direction. As shown in FIG. 6, the first rear bracket 25A is disposed at a position to the right of, and spaced apart from the exhaust-side surface 1H. The second rear bracket 25B extends in the left-right direction between the first rear bracket 25A and the exhaust-side surface 1H. The right end portion of the second rear bracket 25B is fixed to the rear end portion of the first rear bracket 25A with a bolt. The left end portion of the second rear bracket 25B is fixed to the exhaust-side surface 1H with a bolt. Specifically, a boss 115 protruding toward the right is provided at the rear end portion of the right side surface of the cylinder block 1E at a position in the vicinity of the center in the up-down direction, the right side surface of the cylinder block 1E forming a portion of the exhaust-side surface 1H. The left end portion of the second rear bracket 25B is fixed to this boss 115 with a bolt. As described previously, the second connecting passage 7 is supported on the right side surface of the cylinder block 1E via the rear bracket 25 and, as a result, the exhaust module 20 is supported. Particularly, in the present embodiment, the rear bracket 25 supports, on the right side surface of the cylinder block 1E, the rear end portion of the catalyst device 6 and the left end portion of the filter 8 via the second connecting passage 7.

As shown in FIG. 3 and the like, the lower bracket 26 is constituted of two brackets (a first lower bracket 26A, a second lower bracket 26B). The first lower bracket 26A has a substantially plate shape. The first lower bracket 26A is fixed by welding or the like to the lower surface of the exhaust module 20 in an attitude extending rearward from this lower surface. As shown in FIG. 7 and the like, the first lower bracket 26A is fixed to each of the lower surface of the catalyst device 6, the lower surface of the second connecting passage 7, and the lower surface of the filter 8, and extends downward from these lower surfaces. The first lower bracket 26A is disposed at a position to the right of, and spaced apart from the exhaust-side surface 1H. As shown in FIG. 3 and the like, the second lower bracket 26B extends in the left-right direction between the first lower bracket 26A and the exhaust-side surface 1H. The right end portion of the second lower bracket 26B is fixed to the lower end portion of the first lower bracket 26A with a bolt. The left end portion of the second lower bracket 26B is fixed to the exhaust-side surface 1H with a bolt. Specifically, a boss 116 protruding toward the right is provided to the right side surface of the cylinder block 1E at a position in the vicinity of the center in the front-and-rear direction and the up-down direction, the right side surface of the cylinder block 1E forming the portion of the exhaust-side surface 1H. The left end portion of the second lower bracket 26B is fixed to this boss 116 with a bolt. As described previously, the exhaust module 200 is supported on the right side surface of the cylinder block 1E via the lower bracket 26. To be more specific, the lower bracket 26 supports, on the right side surface of the cylinder block 1E, the catalyst device 6, the catalyst device 6, the second connecting passage 7, and the filter 8 from below.

### Manner of Operation and the Like

As has been described above, in the exhaust structure of an engine according to the above-mentioned embodiment, the catalyst device 6 and the filter 8 are provided in the exhaust passage 2. Therefore, it is possible to improve the exhaust performance of the engine E.

Both the first connecting passage 5 and the first EGR passage 41 are fixed to the exhaust-side surface 1H at portions located higher than the catalyst device 6 and the filter 8, the first connecting passage 5 connecting the respective exhaust port opening ends 12A to the upstream end of the catalyst device 6, the first EGR passage 41 being connected to the second connecting passage 7, which connects the downstream end of the catalyst device 6 to the upstream end of the filter 8. Therefore, in the above-mentioned embodiment, the respective passages 5, 41, 7 can be caused to serve as passages through which exhaust gas or EGR gas flows, and the respective passages 5, 41, 7 can also be caused to serve as members that suspend the upstream end and the downstream end of the catalyst device 6 and the upstream end of the filter 8 on the exhaust-side surface 1H, the catalyst device 6 having a relatively large weight, the filter 8 having a relatively large weight. Further, in the above-mentioned embodiment, the first connecting passage 5 includes the plurality of independent passages 51 (511 to 513) individually connected to the respective exhaust port opening ends 12A. Therefore, it is possible to support the catalyst device 6 by the plurality of independent passages 51. Accordingly, according to the above-mentioned embodiment, according to the above-mentioned embodiment, the number of support members for supporting the catalyst device 6 and the filter can be reduced, thereby simplifying the support structure for the catalyst device 6 and the filter, and the catalyst device 6 and the filter 8 can be supported on the exhaust-side surface 1H in a stable manner.

In the above-mentioned embodiment, the catalyst device 6 is disposed in an attitude extending in the front-rear direction, the first connecting passage 5 is connected to the front end portion of the catalyst device 6, and the second connecting passage 7 is connected to the rear portion of the catalyst device 6, the first EGR passage 41 being fixed to the second connecting passage 7. Therefore, both ends of the catalyst device 6 in the longitudinal direction can be suspended by the first connecting passage 5 and the first EGR passage 41 and hence, the catalyst device 6 can be reliably stabilized.

In the above-mentioned embodiment, the first connecting passage 5 is provided with the collecting passage 52 that is connected to the downstream ends of the respective independent passages 51 (511 to 513) (in the flow direction of exhaust gas) to collect exhaust gas that passes through the respective independent passages 51 (511 to 513). Therefore, compared with the case in which the entire first connecting passage 5 is formed of the plurality of independent passages 51, it is possible to reduce a space occupied by the first connecting passage 5. Accordingly, the catalyst device 6 can be supported on the exhaust-side surface 1H in a stable manner by the plurality of independent passages 51, and the first connecting passage 5, that is, the exhaust passage 2, can be made compact.

In the above-mentioned embodiment, the swirling part 53, which causes exhaust gas to swirl, is provided at a portion that connects the collecting passage 52 to the catalyst device 6. Therefore, it is possible to cause exhaust gas to flow into the catalyst device 6 after the exhaust gas is dispersed and hence, the exhaust gas can be uniformly introduced into the catalyst device 6. Accordingly, it is possible to efficiently purify exhaust gas with the entire catalyst device 6, thereby improving the exhaust performance of the engine E.

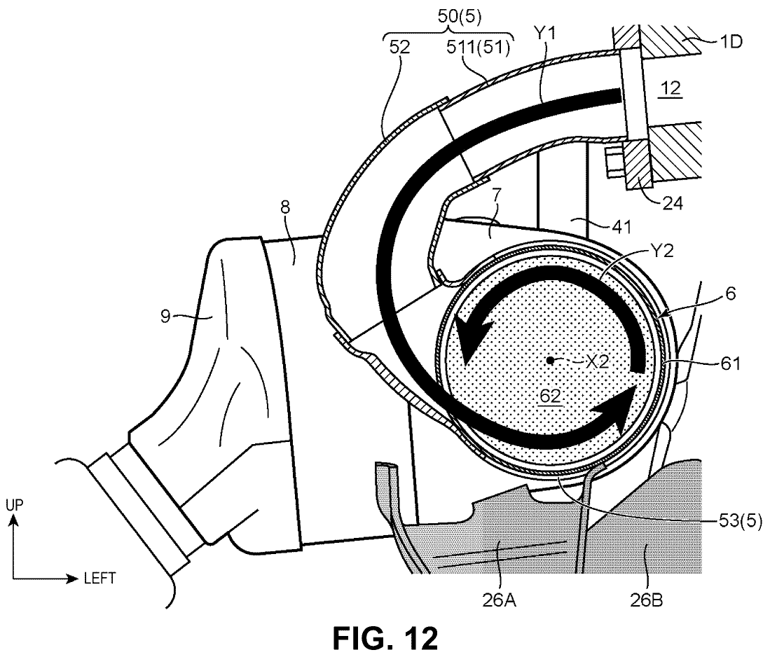

In addition, the entire upstream-side passage 50, which is formed of the independent passages 51 and the collecting passage 52, is smoothly bent in such a way as to bulge toward the right from the exhaust port opening ends 12A and to extend downward, and both of the flow of exhaust gas in the upstream-side passage 50 and the flow of exhaust gas in the swirling part 53 flow about the axis extending in the front-rear direction. Therefore, as shown by arrows Y1 and Y2 in FIG. 12, exhaust gas led out from the respective exhaust port opening ends 12A can be caused to smoothly and vigorously flow into the swirling part 53, thereby promoting the swirling and dispersion of the exhaust gas in the swirling part 53.

The swirling part 53 has the shape that covers the front end of the catalyst device 6 from the front and hence, it is possible to support the front end of the catalyst device 6 in a more stable manner by the first connecting passage 5.

In the above-mentioned embodiment, the respective exhaust port opening ends 12A (121A to 123A) are formed at the center portion of the exhaust-side surface 1H in the cylinder arrangement direction. Therefore, the plurality of (three) independent passages 51 (511 to 513), extending from the respective exhaust port opening ends 12A, can be disposed close to each other and hence, these independent passages 51 (511 to 513) can be disposed in a compact manner.

In the above-mentioned embodiment, the filter 8 is provided at the position that overlaps with the catalyst device 6 when viewed in the left-right direction. Therefore, it is possible to reduce the dimensions in the front-and-rear direction and the up-down direction of the space occupied by the catalyst device 6 and the filter 8 and hence, the catalyst device 6 and the filter 8 can be disposed in a compact manner.

In the above-mentioned embodiment, the first connecting passage 5 and the first EGR passage 41 are fixed to the cylinder head 1D and, in addition to the above, the rear bracket 25 and the lower bracket 26, which support the catalyst device 6 and the filter 8, are fixed to the cylinder block 1E. Therefore, it is possible to support the catalyst device 6 and the filter 8 on the cylinder head 1D and the cylinder block 1E in a more stable manner.

In the above-mentioned embodiment, the second EGR passage 42, which is formed in the cylinder head 1D, and which is open on the right side surface 111H of the cylinder head 1D, is provided in the EGR passage 4, and the first EGR passage 41 is fixed to the right side surface 111H of the cylinder head 1D in a state in which the upper end of the first EGR passage 41 is in communication with the opening end of the second EGR passage 42. Therefore, the first EGR passage 41 can be fixed to the right side surface 111H of the cylinder head 1D by making use of a structure for connecting the first EGR passage 41 to the second EGR passage 42 and hence, it is possible to further simplify the structure of the right side surface 111H of the cylinder head 1D on a lateral side.

### Modification

In the above-mentioned embodiment, the description has been made for the case in which the catalyst device 6 is a monolithic catalyst converter. However, the specific structure of the catalyst device 6 is not limited to such a structure. The catalyst supported by the catalyst body 62 is not limited to a three-way catalyst. The filter 8 is not limited to a ceramic filter having a honeycomb structure. The kind and the number of purifying devices provided in the exhaust passage 2 are not limited to the above. For example, two or more catalyst devices, or two or more filters may be provided in the exhaust passage 2. A different device that is capable of purifying exhaust gas may be provided in the exhaust passage 2, in place of or in addition to the catalyst device and the filter.

In the above-mentioned embodiment, the description has been made for the case in which the catalyst device 6 is disposed in an attitude extending along the front-rear direction (cylinder arrangement direction), and the filter 8 is disposed in an attitude extending along the left-right direction (engine width direction). However, the attitudes of the catalyst device 6 and the filter 8 are not limited to such attitudes.

In the above-mentioned embodiment, the description has been made for the case in which the exhaust module 20 is supported on the cylinder block 1E by the rear bracket 25 and the lower bracket 26. However, one of either or both of the rear bracket 25 and the lower bracket 26 may be omitted.

In the above-mentioned embodiment, the description has been made for the case in which the catalyst device 6 overlaps with the filter 8 when viewed in the left-right direction. However, the relative position between the catalyst device 6 and the filter 8 is not limited to such a relative position.

In the above-mentioned embodiment, the description has been made for the case in which the upstream-side passage 50 includes the collecting passage 52, the three independent passages 51 (511 to 513) are collected by the collecting passage 52, and the downstream end of the collecting passage 52 is connected to the swirling part 53. However, the collecting passage 52 may be omitted, and the respective independent passages 51 (511 to 513) may be individually connected to the swirling part 53.

The specific shape of the swirling part 53 is not limited to the above-mentioned shape. For example, in the above-mentioned embodiment, the description has been made for the case in which the upstream-side passage 50 and the swirling part 53 have the shapes in which the separation distance between the inner peripheral surface of the upstream-side passage 50 or the swirling part 53 and the front end surface 6A of the catalyst device 6 in the front-rear direction is smaller at the upper area (d1) than at the lower area (d2), the upper area (d1) being located above the center axis X2, the lower area (d2) being located below the center axis X2. However, the above-mentioned respective distances may be set to the same dimension. Further, the swirling part 53 may be omitted.

In the above-mentioned embodiment, the description has been made for the case in which the exhaust ports 12 corresponding to the two cylinders 1A are collected in the cylinder head 1D. However, the exhaust ports 12 extending from the respective cylinders 1A may be caused to be individually open on the exhaust-side surface 1H without being collected in the cylinder head 1D. In addition, the exhaust port opening ends 12A may be provided at a position offset from the center portion of the exhaust-side surface 1H in the front-rear direction.

In the above-mentioned embodiment, the description has been made for the case in which the number of cylinders of the engine E is four. However, the number of cylinders is not limited to four. In addition, the engine E is not limited to a gasoline engine.

What is claimed is:

1. An exhaust structure of an engine, the exhaust structure comprising: an engine body in which a plurality of cylinders and a plurality of exhaust ports are formed, the plurality of cylinders being arranged in a cylinder arrangement direction, which is predetermined, the plurality of exhaust ports extending from the plurality of cylinders; an intake passage through which intake air to be introduced into the engine body flows; an exhaust passage through which exhaust gas led out from the engine body flows; and an EGR passage connecting the exhaust passage to the intake passage, wherein
when one side in an engine width direction, which is orthogonal to the cylinder arrangement direction and an up-down direction, is taken as an exhaust side, and an opposite side of the exhaust side is taken as an intake side, a plurality of exhaust port opening ends are open on an engine exhaust-side surface which is a side surface of the engine body on the exhaust side, the plurality of exhaust port opening ends being outlets of the plurality of exhaust ports,
the exhaust passage includes
a first purifying device and a second purifying device which are disposed on the exhaust side of the engine body, and arranged in this order in a flow direction of exhaust gas at a height lower than the plurality of exhaust port opening ends,
a first connecting passage that includes a plurality of independent passages fixed to the engine exhaust-side surface in such a way as to be in communication with the plurality of exhaust port opening ends, the first connecting passage connecting the plurality of exhaust port opening ends to an upstream end of the first purifying device, and
a second connecting passage that connects a downstream end of the first purifying device to an upstream end of the second purifying device, and
the EGR passage includes an EGR pipe that connects a portion of the engine exhaust-side surface to the second connecting passage, the portion being located at a position higher than the first purifying device.

2. The exhaust structure of an engine according to claim 1, wherein the first connecting passage includes a collecting passage that is connected to downstream ends of the plurality of independent passages to collect exhaust gas that passes through the plurality of independent passages.

3. The exhaust structure of an engine according to claim 2, wherein
the first purifying device is disposed on the exhaust side of the engine body in an attitude extending along the cylinder arrangement direction,
the first connecting passage includes a swirling part that connects the collecting passage to the first purifying device to cause exhaust gas to swirl in the swirling part,
the swirling part has a shape that covers one end of the first purifying device in the cylinder arrangement direction from the one side, and that causes exhaust gas led out from the collecting passage to swirl about an axis extending along the cylinder arrangement direction, and
the plurality of independent passages and the collecting passage have, as a whole, a shape that is bent in such a way as to bulge toward the exhaust side from the plurality of exhaust port opening ends and to extend downward.

4. The exhaust structure of an engine according to claim 3, wherein the plurality of exhaust port opening ends are formed at a center portion of the engine exhaust-side surface in the cylinder arrangement direction.

5. The exhaust structure of an engine according to claim 4, wherein the second purifying device is provided at a position that overlaps with the first purifying device when viewed along the engine width direction.

6. The exhaust structure of an engine according to claim 5, wherein
the engine body includes a cylinder block and a cylinder head, the plurality of cylinders being formed in the cylinder block, the cylinder head being provided on an upper side of the cylinder block to cover the cylinder block,
the first connecting passage and the EGR pipe are fixed to the cylinder head, and
a block-side support member is fixed to the cylinder block, the block-side support member supporting the first purifying device and the second purifying device.

7. The exhaust structure of an engine according to claim 6, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.

8. The exhaust structure of an engine according to claim 1, wherein the plurality of exhaust port opening ends are formed at a center portion of the engine exhaust-side surface in the cylinder arrangement direction.

9. The exhaust structure of an engine according to claim 1, wherein the second purifying device is provided at a position that overlaps with the first purifying device when viewed along the engine width direction.

10. The exhaust structure of an engine according to claim 1, wherein
the engine body includes a cylinder block and a cylinder head, the plurality of cylinders being formed in the cylinder block, the cylinder head being provided on an upper side of the cylinder block to cover the cylinder block,
the first connecting passage and the EGR pipe are fixed to the cylinder head, and
a block-side support member is fixed to the cylinder block, the block-side support member supporting the first purifying device and the second purifying device.

11. The exhaust structure of an engine according to claim 1, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.

12. The exhaust structure of an engine according to claim 2, wherein the plurality of exhaust port opening ends are formed at a center portion of the engine exhaust-side surface in the cylinder arrangement direction.

13. The exhaust structure of an engine according to claim 2, wherein the second purifying device is provided at a position that overlaps with the first purifying device when viewed along the engine width direction.

14. The exhaust structure of an engine according to claim 2, wherein
the engine body includes a cylinder block and a cylinder head, the plurality of cylinders being formed in the cylinder block, the cylinder head being provided on an upper side of the cylinder block to cover the cylinder block,
the first connecting passage and the EGR pipe are fixed to the cylinder head, and
a block-side support member is fixed to the cylinder block, the block-side support member supporting the first purifying device and the second purifying device.

15. The exhaust structure of an engine according to claim 2, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.

16. The exhaust structure of an engine according to claim 8, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.

17. The exhaust structure of an engine according to claim 9, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.

18. The exhaust structure of an engine according to claim 10, wherein
the EGR passage includes an in-engine EGR passage that is formed in the engine body, and that is open on the engine exhaust-side surface, and
the EGR pipe is fixed to the engine exhaust-side surface in a state in which an upper end of the EGR pipe is in communication with an opening end of the in-engine EGR passage, the opening end of the in-engine EGR passage being on the engine exhaust-side surface.
